(19) United States
(12) Patent Application Publication
(10) Pub. No.: US 2014/0229223 A1
(43) Pub. Date: Aug. 14, 2014

(54) INTEGRATED ERP BASED PLANNING

(71) Applicant: SADAF SHAKIL, Bangalore (IN)

(72) Inventor: SADAF SHAKIL, Bangalore (IN)

(21) Appl. No.: 13/834,321

(22) Filed: Mar. 15, 2013

(30) Foreign Application Priority Data
Feb. 8, 2013 (IN) 549/CHE/2013

(51) Int. Cl. G06Q 10/06

(52) U.S. Cl. CPC G06Q 10/06313
USPC 705/7.23

(57) ABSTRACT

Various embodiments of systems and methods for planning a to-be-planned project are described herein. A project planning framework is provided for planning a to-be-planned project. The project planning framework includes an enterprise applications module storing projects corresponding to a plurality of organizational functions. The project planning framework also includes a data storage module in communication with the enterprise applications module to store identification information of the project objects. The project planning framework may also include a planning model, in communication with the data storage module, to retrieve the identification information of project objects included in the to-be-planned project. The planning model receiving the plan data for the to-be-planned project based on the identification information of the project objects included in the to-be-planned project.

This application claims priority to an Indian Provisional Patent Application serial No: 549/CHE/2013, titled: “INTEGRATED ERP BASED PLANNING AND PROJECT MANAGEMENT”, filed on Feb. 8, 2013, which is hereby incorporated by reference.

### FIELD

Embodiments generally relate to computer systems, and more particularly to methods and systems for planning a to-be-planned project.

### BACKGROUND

Enterprise applications, for example Resource Planning (ERP), based planning applications are popular as they allow users to plan any business projects based on information stored in the ERP system. Typically, an enterprise applications system includes several enterprise applications modules that store organizational information related to different organizational functions. Existing planning applications typically allow a user to develop a project plan on information stored in single one of the enterprise applications modules. Therefore, a user would require different planning applications to plan on information stored in different enterprise applications modules, which is undesirable.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram illustrating a project planning framework, according to an embodiment.

FIG. 2 is a detailed block diagram illustrating the framework of a project planning framework, according to an embodiment.

FIG. 3 is a flow diagram 300 illustrating a method for planning a to-be-planned project, according to an embodiment.

FIG. 4 is a block diagram illustrating an exemplary planning application, according to an embodiment.

FIG. 5 is a block diagram illustrating an exemplary planning application 500 to perform a detailed planning for one of the plan versions of the plan in FIG. 4, according to an embodiment.

FIG. 6 is a block diagram illustrating a computing environment in which the techniques described for generating planning values of a to-be-planned project can be implemented, according to an embodiment.

### DETAILED DESCRIPTION

Embodiments of techniques for integrated ERP based planning are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment. Thus, the appearances of these phrases in various places throughout this specification are not necessarily all referring to the same embodiment. Furthermore, the particular features, structures, or characteristics may be combined in any suitable manner in one or more embodiments.

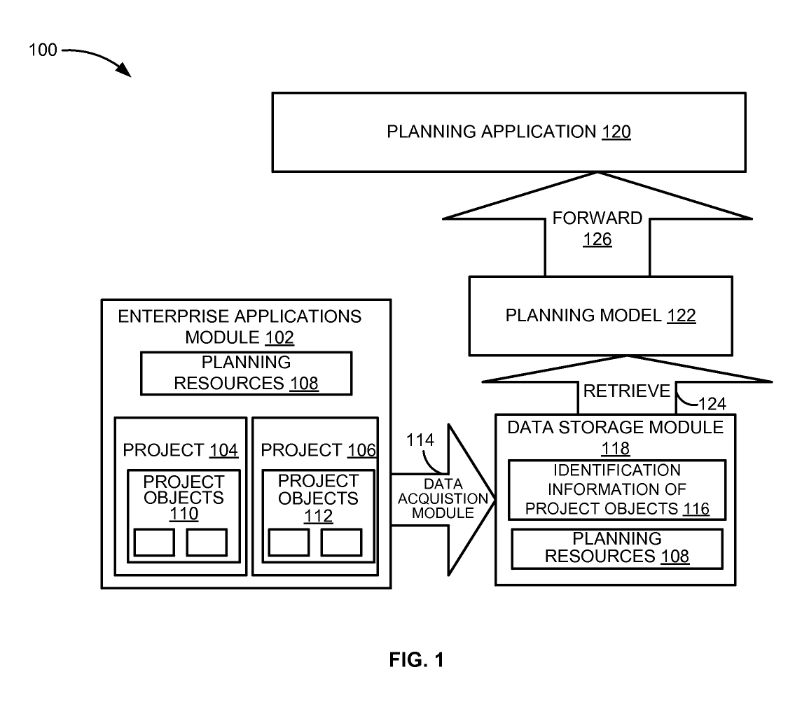

FIG. 1 is a block diagram illustrating a project planning framework 100, according to an embodiment. In one embodiment, a project is a task to achieve a particular goal. Project planning includes defining planning resources that are required for executing the project. For example, consider that a project manager wants to build a campus of a company. In this case, “campus construction” is the project that is to be planned. A project planner may plan this project by defining the planning resources, such as, “construction workers”, “building material”, etc., which are required to construct the campus. The project planner may also define the quantities for the different planning resources such as “number of construction workers” and “quantity of the building material” that are required for constructing the campus.

In one embodiment, a project planning framework 100 may be used for planning a project. The project planning framework 100 includes an enterprise applications module 102 that includes several projects 104 and 106. An enterprise applications module 102, for example an enterprise resource planning (ERP) module, a customer relationship management (CRM) module, etc., is a software package configured to manage information and/or functions of a commercial enterprise. In one embodiment, the enterprise applications module 102 may also include several planning resources 108 that may be used for planning the project. The projects 104 and 106 in the enterprise applications module 102 may correspond to different organizational functions. For example, a project to sell a particular product corresponds to sales and distribution organizational function, and a project to control production of a product may correspond to a control organizational function. In one embodiment, the projects 104 and 106 in the enterprise applications module 102 may include several project objects 110 and 112, respectively. Project objects 110 and 112 may represent a portion of the projects 104 and 106, respectively. For example, a project may include several “work breakdown structure” (WBS) objects. Each of the WBS objects represents a portion of the project. The WBS object may include a model of the work to be performed for the portion of the project Similarly, “sales order” is a project object that represents a portion of a sales and distribution project. In the above example, assume that the project manager specifies that three building are to be included in the campus. In this case, the project construction includes three WBS objects corresponding to the three buildings, to be constructed, in the campus.

In one embodiment, a data acquisition module 114 retrieves the identification information of the different project objects 108 and 110 included in the enterprise applications module 102. The data acquisition module 114 transfers the retrieved identification information 116 to a data storage module 118. In one embodiment, the retrieved identification information 116 of the project objects 110 and 112 includes, for example, a unique identifier representing the project objects 110 and 112, and a description of the project objects 110 and 112. The data acquisition module 114 may also transfer the different planning resources 108 to the data storage module 118. In one embodiment, the data acquisition module 114 may not transform the identification information 116 retrieved from the enterprise applications module 102. The untransformed identification information 116 is then stored in the data storage module 118. In the above example, the data acquisition module 114 may transfer the unique identifiers of the three WBS project objects and the description of these three project objects “construction of building 1”, “construction of building 2”, and “construction of building 3” to the data storage module 118. The data acquisition module 114 may also transfer several planning resources such as “construction workers”, “architects”, and “software engineers” to the data storage module.

A planning application 120 may then use the identification information 116 of the project objects and the planning resources 108 to plan a project. In one embodiment, the project planning framework 100 includes a planning model 122 that retrieves 124 the identification information of project modules included in a to-be-planned project. The retrieved identification information of the project modules may then be forwarded 126 to the planning application 120. The planning model 122 may also retrieve 124 the different planning resources 108 from the data storage module 118 and forward 122 information related to the planning resources 108 to the planning application 120. The identification information of the planning objects of a to-be-planned project and the planning resources 108 may then be displayed at the planning application 120. A user may then select the planning resources, from the displayed planning resources 108, which the user wants for planning the to-be-planned project. In the above example, a planning model may retrieve the unique identifiers of the three project objects and the description of the three project from the data storage module and provides it to the planning application. The different planning resources “construction workers”, “architects” and “software engineers” may also be retrieved from the data storage module and provided to the planning application. A planner may select the “construction workers” and “architects” as the resources for planning the “construction” project.

As the data storage module 118 includes project object identification information 116 for the different projects objects 108 in the enterprise applications module 102, the planning application 120 may plan a project related to any organizational function by retrieving the identification information for project objects. Further, as the data storage module 118 stores the identification information 116 of the different project objects, the planning application 120 is not required to retrieve the project object identification information 116 for each planning session. This helps in reducing the total planning time required for planning a project. Additionally, as the data storage module 118 is only storing the identification information of the project objects, there is no data duplication at the enterprise applications module 102 and the data storage module 118.

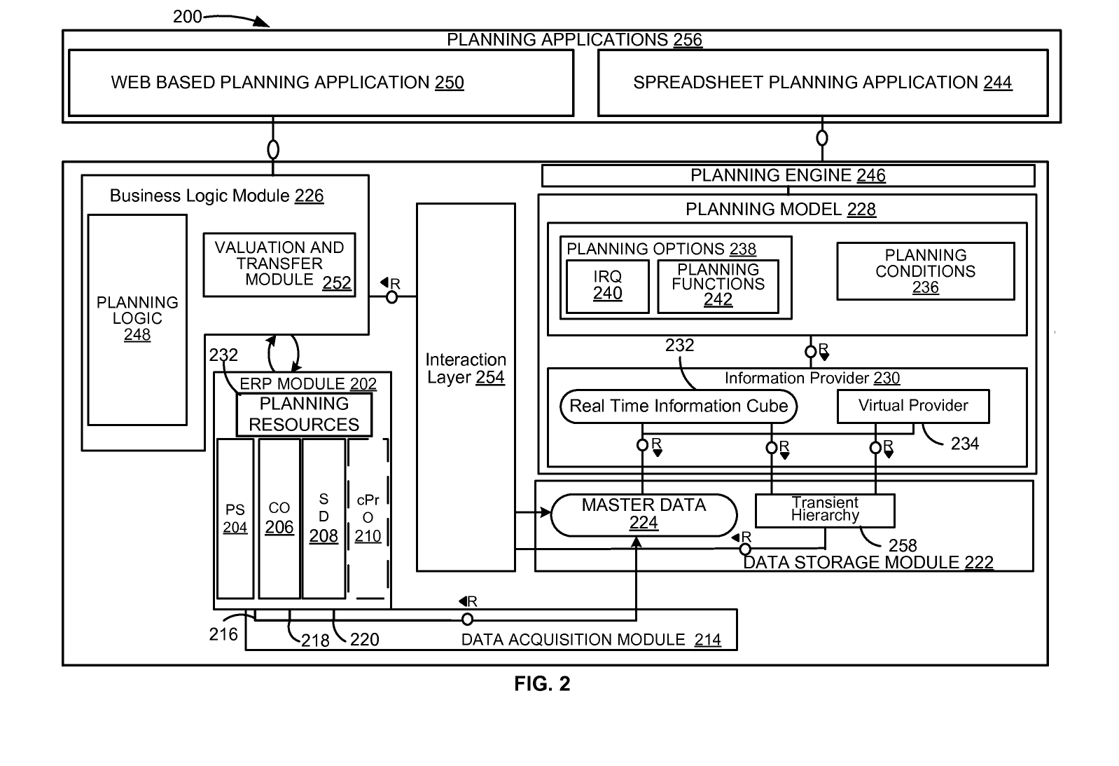

FIG. 2 is a detailed block diagram illustrating a project planning framework 200, according to an embodiment. The project planning framework 200 includes an enterprise applications module 202 that has several business specific sub-modules related to different organizational functions. For example, the enterprise planning applications module 202, may be an ERP module, that include a project system (PS) sub-module 204, a control (CO) sub-module 206, a sales and distribution (SD) sub-module 208, and a collaboration project (cPro) sub-module 210. The enterprise applications module 202 may include several projects corresponding to the different sub-modules of the enterprise applications module 202. For example, the ERP module may include a “construction” project corresponding to the PS sub-module 204, a “product manufacturing control” project corresponding to the CO sub-module 206, and a “product sales and distribution” project corresponding to a SD sub-module 208. Each of the projects, in the enterprise applications module 202, may have several project objects. The projects may be divided according to the different project objects.

The different project objects may be grouped together according to the corresponding object type. For example, the different WBS objects can be grouped together according to the object type “WBS”. Similarly, the different “sales order” objects for the different projects may be grouped together according to the object type “sales order”. In one embodiment, objects of a particular object type divide the project according to a pre-defined structure. For example, WBS objects divided the project according to a hierarchical structure and sales order objects divide project according to a set structure. The enterprise applications module 202 may also store planning resources 212.

In one embodiment, the project planning framework 200 includes a data acquisition module 214 to retrieve identification information of the different project objects included in the projects. The identification information includes a unique identifier and a description of the project objects. The description may include, for example, a task being performed by the project object. In one embodiment, the identification information also include an object type of the different project objects. In the above “construction” project example, assume that the project manager wants to build three floors in building 1, two floors in building 2, and one floor in building 3. In this case, the “construction” project may include nine WBS objects, which represent the three buildings and the six floors in the three buildings. In this case the unique identifiers for the three buildings may be X001, X002, and X003. Further, the unique identifier for the three floor of building 1 may be X0011, X0022, and X0033. Similarly the unique identifiers for the floors in building 2 and building 3 may be X0021 and X0022, and X0031, respectively. The nine WBS objects may have a short description that describes the WBS object. For example, the WBS objects for building 1 may include a description “construction of building 1” for the building 1, “construction of floor 1 of building 1”, “construction of floor 2 of building 1”, and “construction of floor 3 of building 1”.

In one embodiment, the data acquisition module 214 includes several data acquisition elements 216, 218, and 220 that are defined to retrieve identification information for a particular object type. For example, a WBS object specific data acquisition element may be defined to retrieve identification information for all WBS objects in the enterprise applications module 202, a sales order object specific data acquisition element may be defined to retrieve identification information for all sales order objects in the enterprise applications module 202, etc. A real time data acquisition (RDA) technique may be used for retrieving the project objects data from the enterprise applications module 202. A RDA technique includes a permanently running background job for retrieving identification information of different project objects. The RDA technique uses RDA daemons to retrieve the data from the enterprise applications module 202. An RDA daemon is assigned to a particular project object type and retrieves identification information for all project objects corresponding to the particular project object type.

In one embodiment, the data acquisition module 214 also retrieves the planning resources 212 and the planning resource type from the enterprise applications module 202. Planning resources 212 include resources that may be used for planning the project. In the above example, the planning resource may include different type of workers such as architect, carpenters, planners, electrician, etc., different building materials such as brick, cement, etc. The different planning resources can be grouped according to a planning resource type. The above planning resources can be grouped under two planning resource categories, which are “workers” and “building material”. The planning resource category “workers” and “building material” includes planning resources “architect, carpenters, planners, electrician” and “brick, cement”, respectively.

The data acquisition module 214 transfers the retrieved identification information to a data storage module 222. In one embodiment, the data stored in the data storage module 222 is a master data 224 that includes the retrieved identification information of the project objects, the planning resources, and the planning resource types. The master data 224 may also include planning object specific values, received from a business logic module 226. In one embodiment, the master data 224 is stored in a data warehouse included in the data storage module 222. A warehouse is a database used for reporting and data analysis. The warehouse is a central repository of data, which is created by integrating data from one or more disparate sources.

In one embodiment, the project planning framework 200 includes a planning model 228 that provides the data and the planning options 238 for performing a planning operation. In one embodiment, the planning model 228 may be defined at design time. The planning model 228 includes an information provider 230 that provides the data, for example, the data of the project objects and the planning resources for planning a project. The information provider 230 may include a real time information cube 232 that retrieves the data from the data storage module 222 for planning a project. The real time information cube 232 may also store the plan data of a project obtained after planning the project. An information cube is a set of relational tables arranged according to the star schema. The information cube includes a fact table in the middle surrounded by several dimension tables. In one embodiment, the dimension table in the real time information cube 232 accesses the data in the data storage module 222 using a surrogate ID (SID) table. The dimension table contain a dimension ID and a SID of a particular table in the data storage module 222. Using the SID, the information cube accesses the attributes and texts in the data storage module 222. A real time information cube 232 allows both read and write operation on the information cube.

At design time a set of dimensions and measures are defined for a real time information cube 232. The real time information cube 232 may be activated after defining the real time information cube 232. At run-time, the real time information cube 232 may store a plan data corresponding to the dimensions and measures defined in the real time information cube 232. In one embodiment, the measures defined in the information cube may include, for example, quantity, cost, revenue, percentage of completion, etc. The dimensions in the information cube may include, for example, a client dimension that identifies the client for which the planning was done, a to-be-planned project business object dimension that identifies the project for whom the planning is performed, a planning object that includes planning header information, planning version information and, a planning scenario information, and a multi resource scheduling (MRS) document number dimension that identifies an MRS document number for a particular Project object of a project. Multi Resource Scheduling (MRS) is a solution for resource management in the service and in the project business service planning status. Further, the real time information provider 230 includes a cost dimension that identifies the cost based on a selected planning resource. In one embodiment, the information provider 230 module also includes a virtual provider 234 that accesses the data values obtained after executing a plan. In the above example, assume that for planning construction of the three buildings a planner allocates twenty five workers and four architects to work on the construction project for a week. Based on the plan, the amount of construction work completed by these workers and architects at the end of a week may be accessed by the virtual provider. The information accessed by the virtual provider 234 may be later used for report generation.

In one embodiment, the planning model 228 includes different planning conditions 236 that are to be used for planning a project. The planning conditions 236 may include for example, a characteristic relationship, data slices, aggregation level, and filters. Characteristic relationship is used to model semantic relationships between different dimensions during planning. Characteristic relationship providers a check on whether a particular combination of dimensions can be generated or whether a cell is input ready. For example, a characteristic relation may be defined that for a US based job opening only candidates located in US can apply. This characteristic relationship may be used to check the valid candidates during resource planning for a project in a US office. Data slices are used to define portions of data as read only. This ensures that planning is not performed in invalid scenarios, for example, if the status of a planning dimension or a planning measure is read only. An aggregation level determines the level on which data can be entered or changed (manually through user input or automatically by a planning function). The aggregation level consists of a subset of the dimensions and measures in a real time information cube 232. A filter describes a section of a dataset which is processed, for example, in a query or a planning function. (For example, calendar year 2004-2005, customer group XY).

The planning model 228 also includes several planning options 238 that may be used for planning a project. In one embodiment, the planning options 238 include an input ready query (IRQ) 240 that allows manual planning and planning functions 242 that automatically determine the planning data. Planning conditions 240 includes planning parameters that are to be used for planning the project. The planning parameters include planning dimension parameters and planning measure parameters. The value for the different planning parameters may be retrieved from the data storage module 222 or may be received from a user. A planning function may allow system-based processing or generation of data. The planning functions 242 allow system-supported editing and generation of data. The planning functions 242 may include, for example, a unit conversion, copy, delete, forecasting, repost, etc. In one embodiment, a metadata of the planning options 238 may be embedded in a planning application.

During run time of the planning operation, the planning engine 246 may execute the planning options 238 in the planning model 228 to obtain the plan data. In one embodiment, the project planning framework 202 includes a business logic module 226 that includes business logic for the planning operation. The business logic module 226 includes a planning logic 248 that stores a planning business object. A planning business object includes header information and the different versions for a plan. The planning business object is used for triggering a planning operation for a project. The header information may include the name of the project for which the planning is to be triggered and a planning scenario that defines one or more planning conditions 236 depending on the type of the project. For example, a planning scenario may define that for a construction project the planning resources suggested should not include a software developer. The header information may also include the plan currency and the duration for which the plan is to be generated. The planning business object also includes a list of the different version of the plan that the user wants to generate. The different versions represent the number of plans to be built for a particular project. In one embodiment, the planning business object is generated at a web based planning application. In one embodiment, the plan header information, plan scenario, and project information stored in the planning business object is transferred to the business storage module via an interaction layer 254. Business warehouse APIs may be used for transferring this information form the planning business object to the data storage module 222.

In on embodiment, the business logic module 226 includes a valuation and transfer module 252 that provides integration between the different sub-modules of the enterprise applications module 202. The valuation and transfer module 252 may be used for transferring the plan data, obtained after planning, stored in the real time information cube 232 to the enterprise applications module 202. For example, the valuation and transfer module 252 may transfer plan data to an ERP controlling sub-module 206, where the data can be used for existing legacy report. The valuation and transfer module 252 is used for determining plan data, for a planning parameter, for example, cost or revenue, etc. based on the plan data of any other parameter. The valuation and transfer module 252 may use the rates maintained in a SD sub-module 208 to determine these values. For example, if a user selects a certain number of construction workers for a project in US then the valuation and transfer module may provide the cost of hiring these workers based on the rates maintained in the enterprise applications module 202.

In one embodiment, the project planning framework 200 also includes planning applications 256 for planning a project. The planning applications 256 may include a web based planning application and a spreadsheet planning application 244. The web based planning application is used for defining a planning object and triggering a planning operation for planning a project. Based on the triggering of the planning operation, a spreadsheet planning application 244 may be opened to receive plan data for the project. The spreadsheet planning application 244 may include embedded planning options 238 for planning the project. The planning options 238 may include planning dimension parameters and planning measure parameters. The identification information for the project objects included in a to-be-planned project may be retrieved from the data storage module 222. In one embodiment, hierarchical information of the project objects in the projects, stored in the enterprise applications module 202, may be retrieved, after receiving the planning request. The retrieved transient hierarchy 258 may not be stored in the data storage module 222. The transient hierarchy 258 may be used to arrange the retrieved identification information for the planning dimension parameters. The arranged identification information may then be populated in the spreadsheet planning application 244. A planner may also provide plan data for the planning measure parameters in the planning options 238. The identification information for the planning dimension parameters and planning measure parameters may be stored in the real time information cube 232.

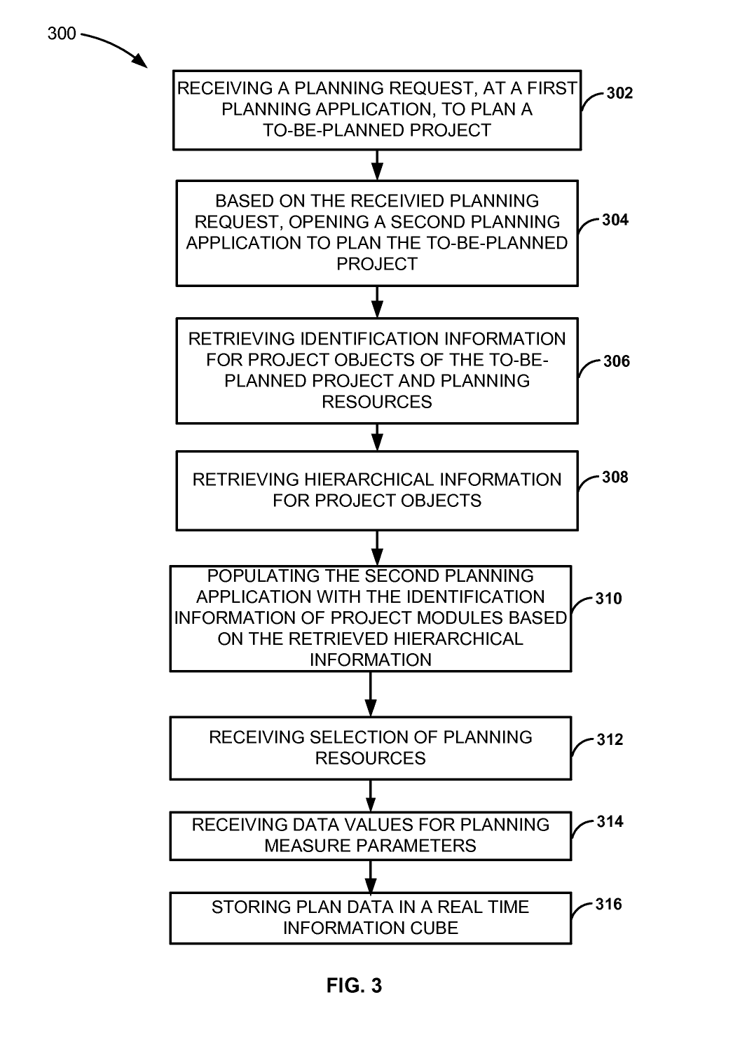

FIG. 3 is a flow diagram 300 illustrating a method for planning a to-be-planned project, according to an embodiment. Initially at block 302, a planning request is received for planning a to-be-planned project at a first planning application. Planning a project may include determining the planning resources, for example, cost, material, human resources, etc., which are required to execute a plan. In one embodiment, the first planning application is a web based planning application. For example, a planning request may be received for “building a product” project that has a primary project object and two secondary project objects dependent on the primary project object.

Based on the received planning request, a second planning application is opened to plan the to-be-planned project (block 304). The second planning application may include one or more planning options, for example, input ready query, planning function, etc. The planning options may include planning parameters for planning the project. The planning parameters may be planning dimension parameters, for example, identification information of the project objects, resources, etc., and planning measure parameters, for example, revenue, quantity, etc. In one embodiment, the planning application is a spreadsheet planning application, for example, a Microsoft® Excel® workbook. In the above example, a spreadsheet planning application, which included a planning option, may be opened for planning the “building a product” project. The planning option may include planning dimension parameters (“identification information of the project objects” and “resources”) and planning measure parameters (“quantity” and “cost”).

Next at block 306, the identification information for the project objects of the to-be-planned project may be retrieved from the data storage module. The planning resources may also be retrieved from the data storage module. In one embodiment, the identification information of the project objects and the planning resources are retrieved based on the planning dimension parameters included in the planning option. The identification information of the three modules may be retrieved from the data storage module. Next at block 308, hierarchical information of the project objects is retrieved from a data storage module. In the above example, the hierarchical information for the three project objects is that the secondary WBS objects are dependent on primary WBS object.

Next at block 310 the identification information of the project objects, retrieved at block 306, are populated in a planning application based on the retrieved hierarchical information. In the above example, the data for the three WBS objects is populated in a planning application. Based on the retrieved hierarchical information, the data for the primary WBS object may be listed first followed by the data for the secondary WBS objects. Next at block 312, planning resources may be selected for the project objects of the project, from the planning resources retrieved at block 308. In the above example, a planner may select a software developer as a planning resource for the three modules. In one embodiment, a user may also add a new project object for planning a project. In this case, the user may select the identification information for the new project object in the planning application. Planning resources may then be selected for the new project object

Next at block 314, data values are received for the planning measure parameters included in a planning option of the second planning application. The user may manually provide the data values for the planning measure parameters included in the planning option. The user can use the valuation operation to obtain values for a particular planning parameter based on the provided data values of another planning parameter. In the above example, the planning measure parameters include quantity and cost. A planner may provide the “quantity” of the developers that would be required for each of the planning objects. A valuation operation may then be executed to determine the cost for the developers depending on the quantity of developers selected by the planner. Finally at block 316, the data values in the second planning application are stored in a real time information cube. The information stored in the real time information cube may include the retrieved project objects, the selected planning resources, and the data values provided for planning measure parameters. The stored information, in the real time information cube, may be used for any subsequent project planning

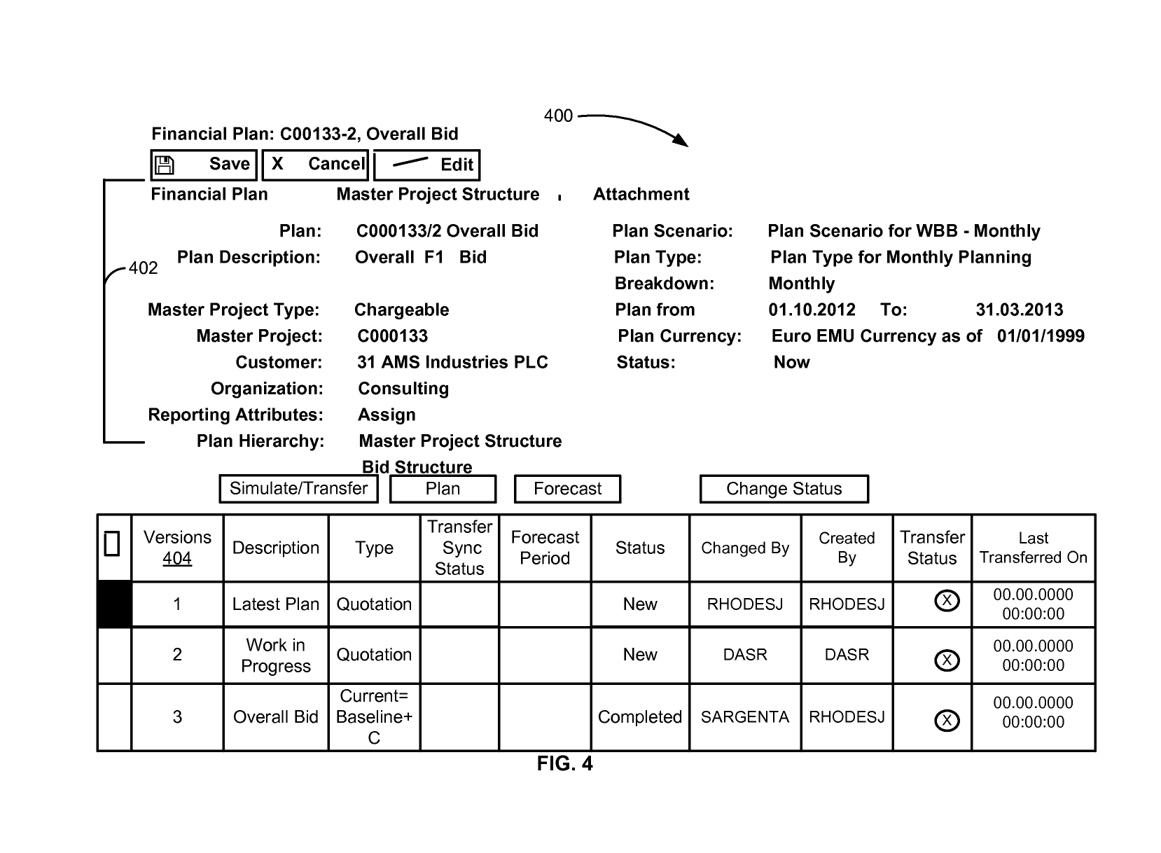

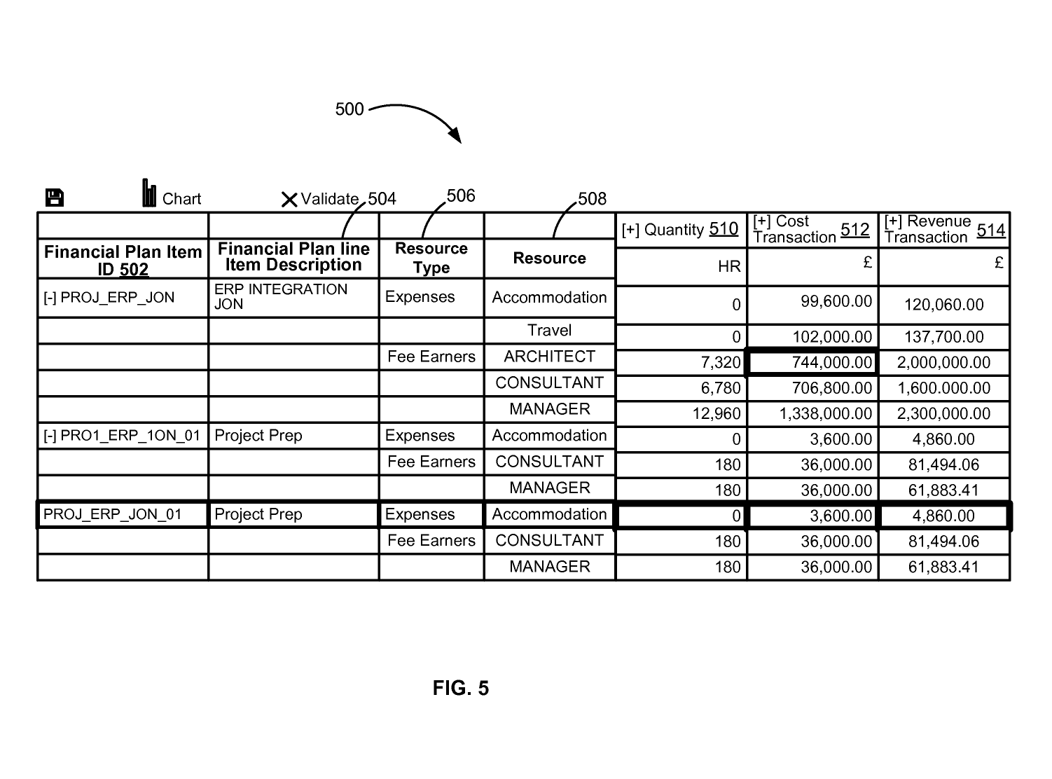

FIG. 4 is a block diagram illustrating an exemplary planning application, according to an embodiment. The financial planning application includes a plan header data 402 and different versions 404 of the plan. The plan header data 402 includes project name, organization, and project type. The plan header data 404 also includes the plan details for the plan. FIG. 5 is a block diagram illustrating an exemplary planning application 500 to perform a detailed planning for one of the plan versions 404 of the plan in FIG. 4, according to an embodiment. The planning application 500 includes an embedded planning option, which is an input ready query. The input ready query includes planning measures “Financial Plan Item ID” 502, “Financial Plan line item description” 504, “Resource Type” 506, “Resource” 508, and measures “Quantity” 510, “Cost” 512, and “Revenue” 514. The “financial plan item ID” 502 and “financial plan line item description” 504 values include the identification information and description of the project objects in the “C000183” project. These objects are arranged according to their hierarchical order. Different options may be provided for selecting the resource type 506 and resources 508 for each of the project objects. The planner may select the resource type 506 and the resource type 508 values from the different options. The user may also select the values for the different dimensions. The obtained value for the planning dimensions and the planning measures are stored in a real time information cube.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

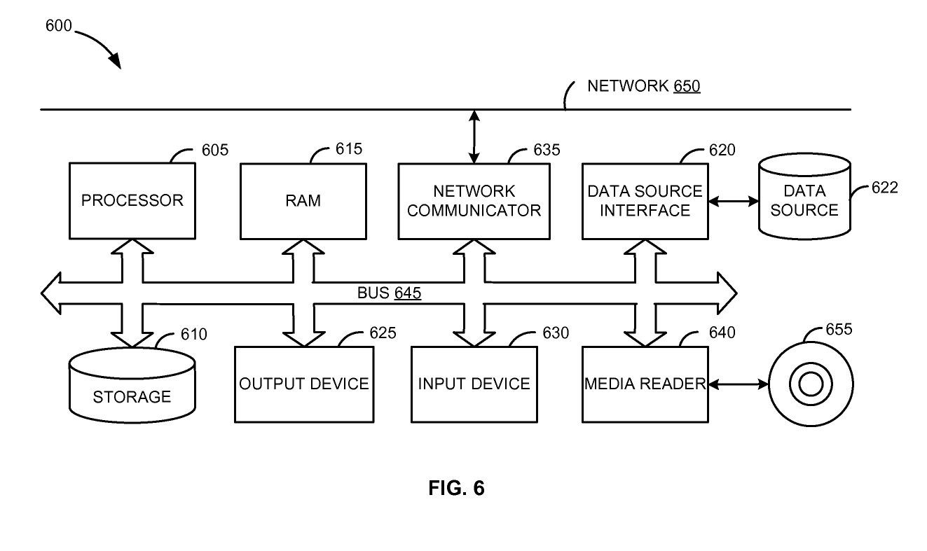

FIG. 6 is a block diagram of an exemplary computer system 600. The computer system 600 includes a processor 605 that executes software instructions or code stored on a computer readable storage medium 655 to perform the above-illustrated methods. The processor 605 can include a plurality of cores. The computer system 600 includes a media reader 640 to read the instructions from the computer readable storage medium 655 and store the instructions in storage 610 or in random access memory (RAM) 615. The storage 610 provides a large space for keeping static data where at least some instructions could be stored for later execution. According to some embodiments, such as some in-memory computing system embodiments, the RAM 615 can have sufficient storage capacity to store much of the data required for processing in the RAM 615 instead of in the storage 610. In some embodiments, all of the data required for processing may be stored in the RAM 615. The stored instructions may be further compiled to generate other representations of the instructions and dynamically stored in the RAM 615. The processor 605 reads instructions from the RAM 615 and performs actions as instructed. According to one embodiment, the computer system 600 further includes an output device 625 (e.g., a display) to provide at least some of the results of the execution as output including, but not limited to, visual information to users and an input device 630 to provide a user or another device with means for entering data and/or otherwise interact with the computer system 600. Each of these output devices 625 and input devices 630 could be joined by one or more additional peripherals to further expand the capabilities of the computer system 600. A network communicator 635 may be provided to connect the computer system 600 to a network 650 and in turn to other devices connected to the network 650 including other clients, servers, data stores, and interfaces, for instance. The modules of the computer system 600 are interconnected via a bus 645. Computer system 600 includes a data source interface 620 to access data source 660. The data source 660 can be accessed via one or more abstraction layers implemented in hardware or software. For example, the data source 660 may be accessed by network 650. In some embodiments the data source 660 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the invention are described herein for illustrative purposes, various equivalent modifications are possible within the scope of the invention, as those skilled in the relevant art will recognize. These modifications can be made in light of the above detailed description. Rather, the scope is to be determined by the following claims, which are to be interpreted in accordance with established doctrines of claim construction.

What is claimed is:

1. A project planning framework comprising:
an enterprise applications module including one or more projects corresponding to a plurality of organizational functions, the one or more projects including a plurality of project objects;
a data storage module, in communication with the enterprise applications module, to store an identification information of the plurality of project objects; and
a planning model in communication with the data storage module, to retrieve an identification information of one or more project objects, from the identification information of the plurality of project objects, included in a to-be-planned project, the planning model receiving plan data for the to-be-planned project based on the identification information of the one or more project objects.

2. The project planning framework of claim 1, wherein the project planning framework includes a data acquisition module to retrieve the identification information, of the plurality of project objects and to transfer the retrieved identification information to the enterprise applications module, wherein the data acquisition module includes:
a plurality of data acquisition elements to transfer data objects according to an object type of the plurality of data objects.

3. The project planning framework of claim 1, wherein the project planning framework includes an interaction layer to transfer hierarchical information of the one or more project objects from the enterprise applications module to the data storage module, the interaction layer transferring the hierarchical information upon receiving a plan request for the to-be-planned project.

4. The project planning framework of claim 1, wherein the planning model includes one or more planning options to plan the to-be-planned project, the planning options including a plurality of planning parameters.

5. The project planning framework of claim 1, further comprising:
a planning engine in communication with the planning model, the planning engine executing the planning model to retrieve the identification information of the one or more project objects.

6. The project planning framework of claim 1, wherein the planning model includes:
a real-time information cube to retrieve the identification information of the one or more planning resources from the data storage module, the real-time information cube storing the plan data for the to-be-planned project.

7. The project planning framework of claim 1, wherein the planning model includes:
one or more planning conditions to validate the plan data for the to-be-planned project; and
one or more planning options to provide options for generating the plan data.

8. The project planning framework of claim 7, further comprising:
a planning application in communication with the planning model, the planning application receiving the plan data based on at least one of the one or more planning options in the planning model.

9. A computer implemented method for planning a to-be-planned project, the method comprising:
at a planning application, receiving a planning request for a to-be-planned project, from a plurality of projects corresponding to a plurality of organizational functions;
based on the received planning request, executing, by a processor of the computer, a planning engine to retrieve identification information of one more project objects included in the to-be-planned project;
executing, by the processor of the computer, the planning engine to retrieve a plurality of planning resources; and
at the planning application, receiving a selection of one or more of the plurality of planning resources corresponding to the one or more project objects, to plan the to-be-planned project.

10. The computer implemented method of claim 9, further comprising:
executing, by the processor of the computer, the planning engine to retrieve hierarchical information of the one more project objects; and
based on the retrieved hierarchical information, populating, by the processor of the computer, the planning application with the retrieved one or more project objects.

11. The computer implemented method of claim 9, further comprising:
retrieving, by the processor of the computer, the identification information of the one or more project objects from an enterprise applications module;
storing the retrieved identification information in a data storage module; and
executing, by the processor of the computer, the planning engine to retrieve the identification information from the data storage module.

12. The computer implemented method of claim 9, further comprising:
at the planning application, receiving a selection of a project object for planning the to-be-planned project.

13. An article of manufacture including a computer readable storage medium to tangibly store instructions, which when executed by a computer, cause the computer to:
receive a planning request for the to-be-planned project, from a plurality of projects corresponding to a plurality of organizational functions;
based on the received planning request, execute a planning engine to retrieve identification information of one more project objects included in a to-be-planned project;
execute, the planning engine to retrieve a plurality of planning resources; and
receive a selection of one or more of the plurality of planning resources corresponding to the one or more project objects, to plan the to-be-planned project.

14. The article of manufacture according to claim 13, further comprising instructions which when executed by the computer further causes the computer to:
execute the planning engine to retrieve hierarchical information of the one more project objects; and
based on the retrieved hierarchical information, populate the planning application with the retrieved one or more project objects.

15. The article of manufacture according to claim 13, further comprising instructions which when executed by the computer further causes the computer to:
retrieve the identification information of the one or more project objects from an enterprise applications module;
store the retrieved identification information in a data storage module; and
execute the planning engine to retrieve the identification information from the data storage module.

16. The article of manufacture according to claim 13, further comprising instructions which when executed by the computer further causes the computer to:
receive a selection of a project object for planning the to-be-planned project.

17. A computer system for planning a to-be-planned project, the computer system comprising:
a memory to store program code; and
a processor communicatively coupled to the memory, the processor configured to execute the program code to:
receive a planning request for the to-be-planned project, from a plurality of projects corresponding to a plurality of organizational functions;
based on the received planning request, execute a planning engine to retrieve identification information of one more project objects included in the to-be-planned project; and
execute, the planning engine to retrieve a plurality of planning resources; and
receive a selection of one or more of the plurality of planning resources corresponding to the one or more project objects, to plan the to-be-planned project.

18. The system of claim 17, wherein the processor further executes the program code to:
execute the planning engine to retrieve hierarchical information of the one more project objects; and
based on the retrieved hierarchical information, populate the planning application with the retrieved one or more project objects.

19. The system of claim 17, wherein the processor further executes the program code to:
retrieve the identification information of the one or more project objects from an enterprise applications module;
store the retrieved identification information in a data storage module; and
execute the planning engine to retrieve the identification information from the data storage module.

20. The system of claim 17, wherein the processor further executes the program code to:
receive a selection of a project object for planning the to-be-planned project.
